(19) United States
(12) Patent Application Publication
(10) Pub. No.: US 2013/0125456 A1
(43) Pub. Date: May 23, 2013

(54) RING FOR PROTECTING PLANT

(71) Applicant: Michael L. Strubel, Navarre, OH (US)

(72) Inventor: Michael L. Strubel, Navarre, OH (US)

(21) Appl. No.: 13/680,046

(22) Filed: Nov. 17, 2012

Related U.S. Application Data
(60) Provisional application No. 61/560,825, filed on Nov. 17, 2011.

(51) Int. Cl. A01G 13/00

(52) U.S. Cl. CPC A01G 13/00
USPC 47/32.8; 47/32.7

(57) ABSTRACT

A device for protecting a plant includes a body having an open top and an open bottom. The body may be tapered. The body can be pushed into tilled soil around a plant by a person pressing down on the upper edge of the body. The device is used to protect a plant from damage from nearby hoeing, tilling, mowing or other tool use. The device prevents an animal from digging directly next to the roots of a plant. The device localizes water and fertilizer usage to the soil immediately around plant 4.

### CROSS REFERENCE TO RELATED APPLICATIONS

This application claims the benefit of U.S. Provisional Patent Application Ser. No. 61/560,825 filed Nov. 17, 2011; the disclosures of which are incorporated herein by reference.

### BACKGROUND OF THE DISCLOSURE

1. Technical Field

This disclosure generally relates to devices used to protect plants disposed in soil and, more particularly, to a ring that is pushed directly into the soil around a plant to protect the plant and to retain water immediately around the plant.

2. Background Information

When planting vegetables, flowers, shrubs, bushes or the like, the soil that receives the vegetation may be tilled which allows holes to be readily dug to receive the plants and allows water and nutrients to reach the roots. A drawback with tilled soil is that a heavy rain downpour can wash soil away from the planted vegetation. Another drawback is that the soil readily absorbs water which can cause a gardener who is not careful to waste water by watering sections of the soil which do not support roots.

Other problems faced by a gardener include the possibility of lawn and garden equipment accidentally damaging a plant, the plant's stalk, or extracting a plant's roots. Family pets, neighborhood dogs, and wild animals such as raccoons and skunks also threaten the root system of plants. Replacing damaged plants is expensive, labor intensive and time consuming.

Some plants are provided in degradable containers which are planted in the ground with the plant. The bottom wall of these containers is designed to be removed before planting. The walls of these containers are designed degrade and disappear and may be disposed under the upper level of the ground when planted. The walls are also relatively weak and do not provide suitable protection from animals and power equipment.

### SUMMARY OF THE DISCLOSURE

The disclosure provides a device for protecting a plant that includes a body having a sidewall with an upper edge and a lower edge; the body having an open top and an open bottom; and the body being generally rigid such that it can be pushed into tilled soil around a plant by a person pressing down on the upper edge of the body. The device may be tapered so that they nest together. Different sizes of devices are provided for different plants. Each device may have a lip at its upper edge to give the user a surface against which to push and twist the device into the soil around a plant. The device may be fabricated from a polymer that is water-resistant and is not biodegradable. The body of the device is colored with a dark color that absorbs heat and warms the soil around the plant. The body is strong enough to not collapse after being disposed in water and subjected to a buckling test.

The disclosure also provides a plurality of devices for protecting plants that include a plurality of tapered ring-shaped bodies; each of the bodies having a sidewall with an upper edge and a lower edge; each body defining a lip at the upper edge; each body having an open top and an open bottom; and each body being generally rigid such that it can be pushed into tilled soil around a plant by a person pressing down on the upper edge of the body; and the bodies being nested together for compact storage.

The disclosure also provides a method for protecting a plant disposed in soil in which the method includes the steps of providing a plant protection device having a body defined by a sidewall having an upper edge and a lower edge with an open top and an open bottom; positioning the plant protection device over the plant with the sidewall disposed around at least a portion of the plant; and pushing a portion of the sidewall into the soil.

### BRIEF DESCRIPTION OF THE DRAWINGS

FIG. 1 depicts three exemplary sizes of the rings for protecting plants.

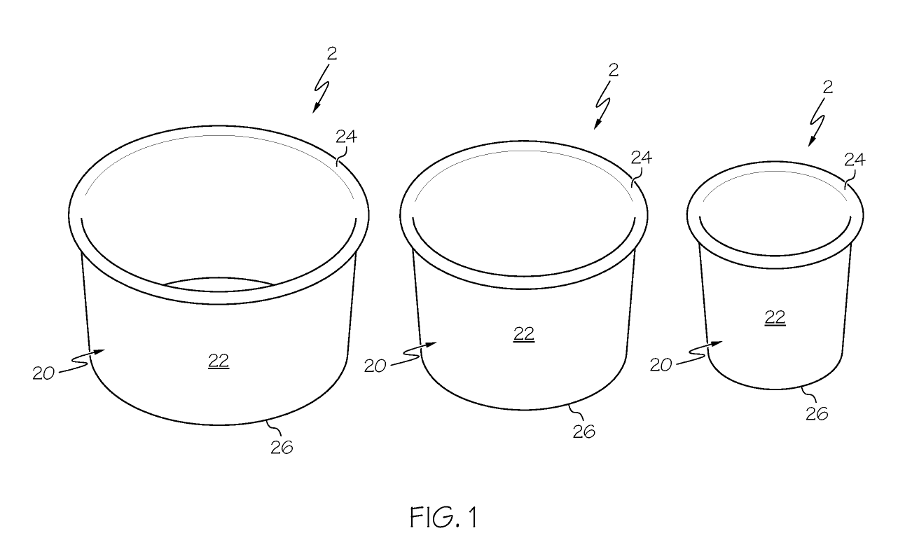

FIG. 2 is a section view showing one of the rings disposed in the soil around a plant.

FIG. 3 shows the different sized rings nested together.

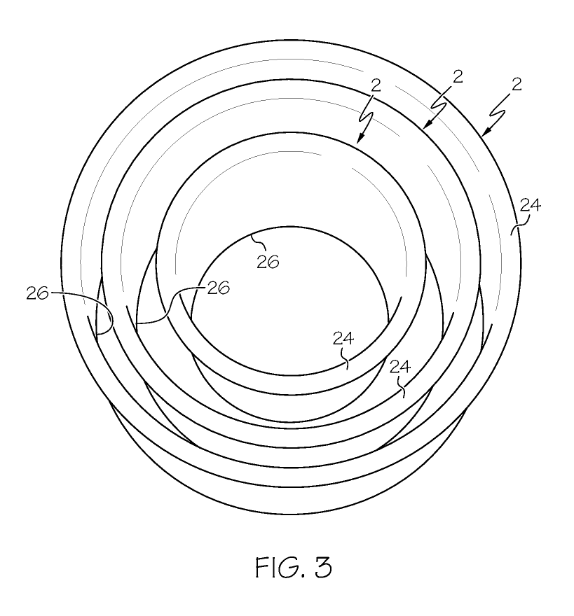

FIG. 4 shows a plurality of same-sized rings nested together and stacked.

FIG. 5 depicts the ring protecting the plant from flowing water.

FIG. 6 depicts water being added to the soil inside the ring.

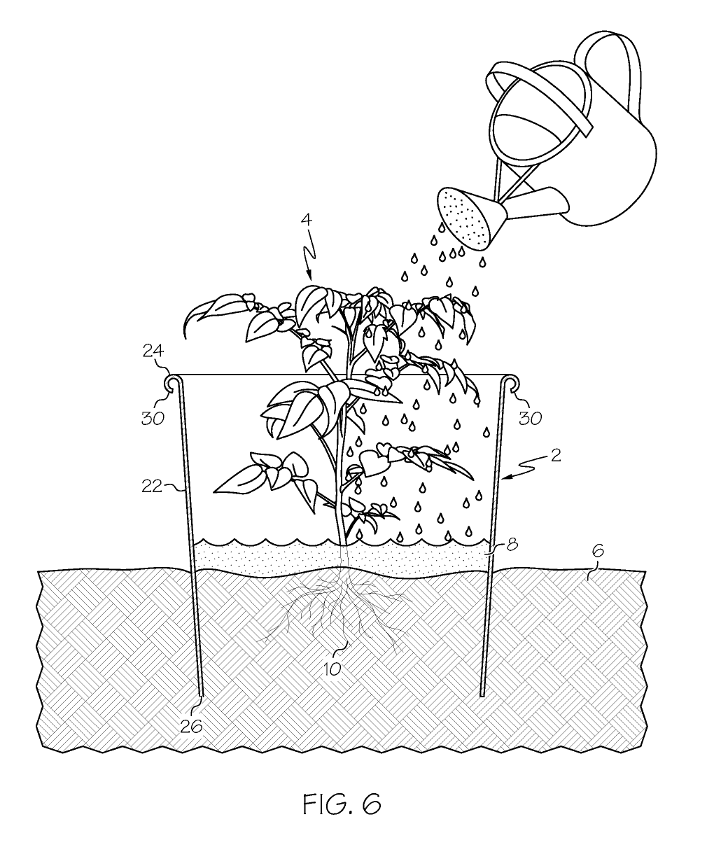

Similar numbers refer to similar elements throughout the application.

### DETAILED DESCRIPTION OF DISCLOSURE

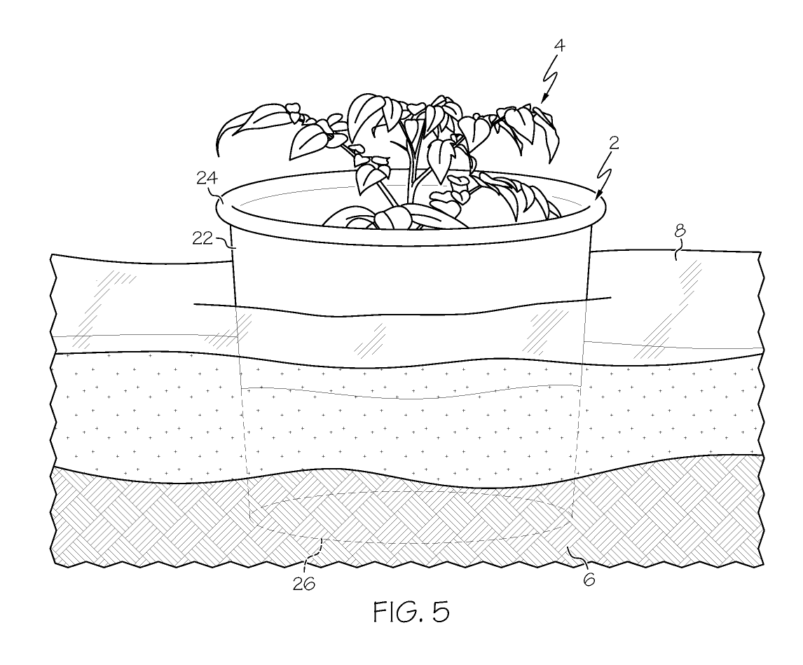

Exemplary configurations of plant protection devices are indicated generally by the numeral 2 in the accompanying drawings. Each device 2 is used to protect at least one plant 4 disposed in soil 6. Multiple plants 4 may be protected by a single device 2 when plants 4 are planted close enough to each other to fit within device 2. Device 2 is used to protect plant 4 from damage from nearby hoeing, tilling, mowing or other tool use. Device 2 also makes it difficult for animals to access plant 4 and prevents an animal from digging directly next to the roots of plant 4 when the animal is digging in the garden. Device 2 also localizes water and fertilizer usage to the soil 6 immediately around plant 4 and thus channels water 8 to the soil supporting roots 10. Usage of devices 2 saves water by preventing the watering of the soil that does not support roots 8. Device 2 may allow water 8 and nutrients to be absorbed slowly into the soil and into the roots, which is especially helpful during a dry season. Device 2 may be used by professional landscapers, gardeners and do-it-yourselfers. FIG. 5 shows how device 2 protects plant 4 from flowing water 8 which can occur after a heavy rain. Device 2 shelters plant 4 from a direct flow and prevents soil 6 immediately around plant 4 from being washed away.

Each exemplary configuration of plant protection device 2 depicted in the drawings has a body 20 that has a sidewall 22 with an upper edge 24 and a lower edge 26. Body 20 is fabricated from a polymer or a metal that is not intended to be biodegradable because device 2 is intended to be at least water resistant and may be waterproof. Steel or aluminum may be used to form body 20. Built-up fiberglass, polyethylene, polypropylene, and PVC may be used to form body 20. When device 2 is used with vegetables, body 20 may be fabricated from a food grade polymer. Lower edge 26 may be rounded or sharpened to help it cut into soil 6. Sidewall 22 is configured to be rigid enough so that it does not buckle or collapse when pushed and twisting into soil. Sidewall 22 is thus rigid enough to withstand at least fifty pounds of downward force without buckling. Another desirable configuration is strong enough to support a downward force of at least 100 pounds without buckling or kinking. Sidewall 22 may be stronger such that it will support over 200 pounds even when wet. The buckling and kinking is tested when sidewall 22 is wet. A test that may be used to measure the strength is to stand body 20 in water deep enough to cover over half of the height of sidewall 22 for one hour. Body 20 is then placed on a flat hard surface such as concrete and a board is placed over the top of body so that upper edge 24 is completely covered. Weight is then placed on the board and left in place for one hour. Sidewall 22 is then inspected for buckling or kinking. Sidewall 22 is rigid enough to be pushed into soil when no kinking is observed when at least 50 pounds does not cause buckling or kinking. Body 20 can be tapered so that they nest together. The tapered body 20 also helps direct water to the roots. Body 20 is dark colored (dark green, dark gray, or black are preferred) to cause body 20 to absorb heat and warm soil 6 around roots 10. The tapered configuration also directs the heat near roots 10.

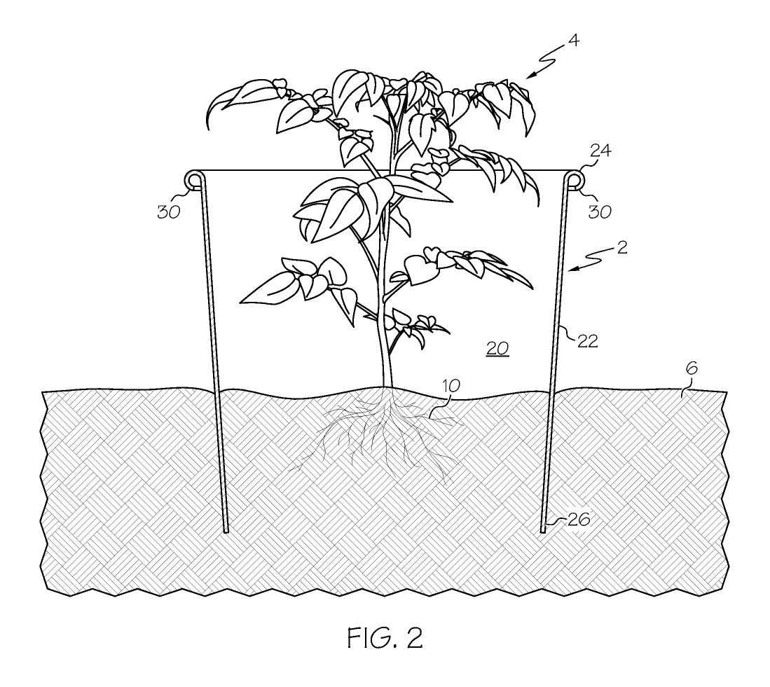

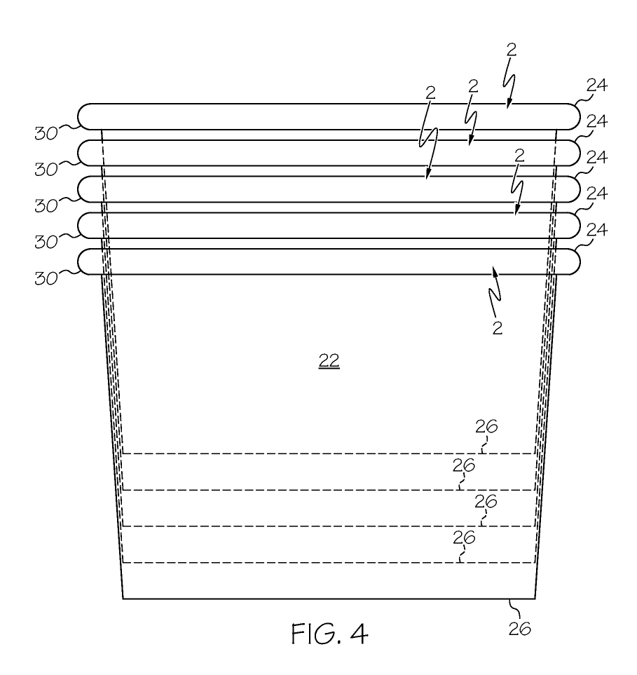

Body 20 has an open top through which plant 4 extends. Body 20 has an open bottom that allows device 2 to be pushed into soil 6 around plant 4. Body 20 is ring-shaped so that device 2 may be twisted as it is pushed down into soil 6. Device 2 may be inserted about a quarter to three-quarter of its height into soil 6. Body 20 has a lip 30 extending outwardly and downwardly from upper edge 24 which provides the user a surface against which to push and a grip on which the user may hold to pull devices 2 apart when they are stacked together as shown in FIG. 4. The tapered body or the portion of body 20 immediately below lip 30 is configured to prevent lips 30 from resting directly against each other (see FIG. 4) so that the user can insert his fingers between lips 30 to separate devices 2. Lip 30 may be one inch wide (in the radial direction). Lip 30 may be formed from a rolled portion of body 20 as shown in FIG. 2 that terminates a distance spaced from sidewall 22 to allow the user's fingers to slip inside lip 30 or lip 30 terminates adjacent or against sidewall 22 so that the user grasps lip 30.

In one configuration, body 20 has a height of ten inches and is provided in three sizes: small, medium and large. The small ring may measure approximately 8″ in width (diameter when circular) at upper edge 24 and tapers to 7½″ at lower edge 26. Sidewall 22 is angled at a 1.432 degree angle from vertical. The medium ring may measure approximately 12″ in width (diameter when circular) and tapers down to 11¼41 at lower edge 26. Sidewall 22 is angled at a 2.148 degree angle from vertical. The large ring may measure approximately 16″ in width (diameter when circular) at upper edge 24 and tapers down to 15″ at lower edge 26. Sidewall 22 is angled at a 2.862 degree angle from vertical. A user may place device 2 over plant 4 and push it into the soil, leaving approximately three inches exposed above ground. Then compost or organic fertilizer may be placed inside device 2 and plant 4 may be watered. When plant 4 no longer needs protection, device 2 does not need to be thrown away—it may be stored for the next use. The exact specifications for device 2 may vary upon manufacturing.

In the context of this application, the term “ring-shaped” includes both circular and noncircular shapes. The term “ring-shaped” specifically includes shapes with flat portions. The easiest way to install device 2 is to twist device 2 about its vertical axis while pushing downward. As such, a cross section that permits twisting is desirable to allow the twisting motion to be effective. Bodies having hexagonal, octagonal, and oval cross sectional shapes allow this motion and are intended to fall under the “ring-shaped” terminology used in this application and in the claims. For example, a sidewall that includes twenty small flat sidewall portions falls under the meaning of ring-shaped.

The foregoing descriptions of the specific embodiments of the disclosure have been presented for purposes of illustration and description. They are not intended to be exhaustive or to limit the claims of the application to the precise forms disclosed, and obviously many modifications and variations are possible in light of the above teaching. The exemplary embodiments were chosen and described in order to best explain the principles of the device and its practical application, to thereby enable others skilled in the art to best utilize the device and various embodiments with various modifications as are suited to the particular use contemplated.

1. A device for protecting a plant comprising:
a body having a sidewall with an upper edge and a lower edge;
the body having an open top and an open bottom; and
the body being generally rigid such that it can be pushed into tilled soil around a plant by a person pressing down on the upper edge of the body.

2. The device of claim 1, wherein the body defines a lip at the upper edge.

3. The device of claim 2, wherein the body has a thickness and the lip has a thickness that is at least twice the thickness of the body.

4. The device of claim 3, wherein the lip is defined by a rolled portion of the body.

5. The device of claim 1, wherein the sidewall is tapered such that a width of the body at the upper edge is larger than a width of the body at the lower edge.

6. The device of claim 1, wherein the body is fabricated from a polymer.

7. The device of claim 6, wherein the body is waterproof.

8. The device of claim 7, wherein the body does not biodegrade.

9. The device of claim 1, wherein the body has a height of about ten inches between the upper and lower edges.

10. The device of claim 9, wherein the body defines a width of about eight inches at its upper edge.

11. The device of claim 9, wherein the body defines a width of about twelve inches at its upper edge.

12. The device of claim 9, wherein the body defines a width of about sixteen inches at its upper edge.

13. The device of claim 1, wherein the sidewall is ring-shaped.

14. The device of claim 13, wherein the body is tapered.

15. The device of claim 1, wherein the body is dark-colored to absorb heat from the sun.

16. A plurality of devices for protecting plants comprising:
a plurality of tapered ring-shaped bodies; each of the bodies having a sidewall with an upper edge and a lower edge; each body defining a lip at the upper edge; each body having an open top and an open bottom; and each body being generally rigid such that it can be pushed into tilled soil around a plant by a person pressing down on the upper edge of the body; and
the bodies being nested together for compact storage.

17. The devices of claim 16, wherein the taper of the body is configured to prevent the lips from resting against each other when the bodies are nested together.

18. A method for protecting a plant disposed in soil; the method comprising the steps of:
providing a plant protection device having a body defined by a sidewall having an upper edge and a lower edge with an open top and an open bottom;
positioning the plant protection device over the plant with the sidewall disposed around at least a portion of the plant; and
pushing a portion of the sidewall into the soil.

19. The method of claim 18, further comprising the step of twisting the device while pushing it into the soil.
